(19) United States
(12) Patent Application Publication
(10) Pub. No.: US 2026/0008543 A1
(43) Pub. Date: Jan. 8, 2026

(54) Weapons Pod For A Low Observable Aircraft And Same

(71) Applicant: Airbus Defence and Space GmbH, Taufkirchen (DE)

(72) Inventor: Wolfgang Stangl, Taufkirchen (DE)

(73) Assignee: Airbus Defence and Space GmbH, Taufkirchen (DE)

(21) Appl. No.: 19/249,228

(22) Filed: Jun. 25, 2025

(30) Foreign Application Priority Data
Jul. 2, 2024 (DE) 102024118744.1

(51) Int. Cl. B64D 7/08

(52) U.S. Cl. CPC B64D 7/08

(57) ABSTRACT

A weapons pod for a low observable aircraft, in particular for a supersonic stealth aircraft, includes a receiving space for a guided missile, at least two pod shell elements which are designed to enclose the receiving space when the weapons pod is in a closed state (C) and to open the receiving space when the weapons pod is in an open state (O) in order to launch the guided missile, and an actuating apparatus which is designed to actuate at least certain portions of the at least two pod shell elements simultaneously and/or sequentially in order to reach the open and/or the closed state. An aircraft, in particular a supersonic stealth aircraft, includes at least one such weapons pod.

### TECHNICAL FIELD

The present disclosure relates to a weapons pod for a low observable aircraft, in particular for a supersonic stealth aircraft, and to an aircraft, in particular a supersonic stealth aircraft.

### TECHNICAL BACKGROUND

The camouflage of vehicles, such as for example military fighter aircraft and equipment, against radar detection is an increasingly frequent requirement for current and future weapons systems. There are various possibilities for reducing detectability by radar systems, such as e.g. reducing the radar backscatter cross section (radar cross section—RCS), by way of radar absorbing material (RAM) and/or radar absorbing structures (RAS). On the basis of these possibilities, the detectability of the aircraft as a whole has to be reduced, that is to say both the aircraft as such and any attachments or loads, such as for example weapons or weapons systems.

Stealth air superiority fighters or stealth aircraft have to carry various types of weapons generally internally in their weapons bay in order to keep their radar cross section low and to obtain an advantage in survivability. The maximum weapons load within the weapons bay is limited by the size of the weapons bay. The size of the weapons bay in turn is a design-critical factor for an overall size of a fighter aircraft.

If, for certain missions, greater weapons loads are intended to be carried, such as for example additional air-to-air weaponry in particular, these additional weapons are according to the prior art usually fastened to pylons below the wings. However, weapons carried in this way dramatically increase the radar cross section of the aircraft, in particular owing to the fact that the pylon, its possible missile launcher rail and a seeker for an air-to-air missile contribute significantly to the overall radar cross section, since these elements are not or cannot be provided with a radar absorber.

DE 10 2004 029 487 B4, for example, relates to an aircraft comprising a weapons bay arrangement, said aircraft having a fuselage with landing gear arranged on a fuselage lower side and with a fuselage upper side arranged opposite thereto, wherein-a weapons carrier device is arranged on the fuselage upper side, —the weapons carrier device, when viewed in the cross section of the fuselage at the location of main landing gear, is arranged above landing gear wells of the main landing gear and above an engine flow duct, —the aircraft has a flight computer device with a control and mission function and an actuating device for the movement of control surfaces for controlling the aircraft, wherein the control and mission function has a flight guidance function for guiding the aircraft to a target point or launching point and a weapon launching function for launching at least one weapon which can be carried in the weapons carrier device based on a specification, —the aircraft has a function respectively assigned to the control and mission function and a flight position sensor system, by means of which the aircraft can be rotated about its longitudinal axis to the degree that a component of the resulting lift force runs from the fuselage lower side counter to the direction of gravity, and—the flight computer device is assigned an altitude sensor and the control and mission function has a terrain-tracking flight function based on the altitude data determined by the altitude sensor.

US 9 180 967 B2 discloses an embodiment of an externally mountable, internally configurable pod structure which minimizes radar signature and induced air resistance and is intended, through configuration and kinematic operation of a pod door arrangement, for the internal placement of one or more deployable stored items. The pod structure comprises, as a type of multi-purpose pod, an externally mountable pod housing with a predetermined cross-sectional configuration, in order to provide a configurable internal volume that can receive multiple different loading configurations, and with a predetermined pod housing configuration with a cross-sectional configuration which is intended to minimize a radar signature and an induced aerodynamic resistance. The pod door arrangement is intended to be integrated in the pod housing and to have multiple pod doors and one or more seal arrangements, which are intended to be able to control launch envelopes.

Conventional approaches for receiving weapons on stealth aircraft thus have the disadvantage that they are either subject to quantitative restrictions of the respective weapons bay if the stealth properties of the aircraft are to be maintained or, when carried on the outside of the aircraft on respective pylons on the wings or other locations on the fuselage, increase the overall radar cross section in such a way that all advantages of other stealth properties would be counteracted dramatically and thus the survivability of the aircraft would be reduced drastically. Pod structures according to the prior art which are fitted to the outside of the aircraft and are intended to receive various additional weapons can indeed alleviate these negative effects, at least to the extent that these pods can be designed in such a way that they do not have an overly negative effect on the radar cross section of the aircraft and they conceal weapons received therein until launch. However, such pod structures according to the prior art greatly increase the air resistance of the aircraft and, due to this and their weight, reduce a respectively possible maximum speed and supersonic capability of the aircraft, which in turn has a negative effect on its performance capability and not least on the maximum ranges that can be reached with the weapons carried.

### Description

The object can be considered that of providing a weapons pod for low observable vehicles, in particular stealth aircraft, with supersonic capabilities. In particular, the aim would be to provide a weapons pod for such aircraft which, on the one hand, does not increase, or at most only insignificantly increases, the radar backscatter cross section of the vehicle, and, on the other hand, does not reduce, or at most only barely reduces, the maximum speed of the aircraft.

This object is achieved by the subject matter of independent claim 1 and also of the additional independent claim 10. Further embodiments emerge from the dependent claims and from the following description.

In particular, the object is achieved by a weapons pod for a low observable aircraft, in particular for a supersonic stealth aircraft, comprising a receiving space for a guided missile, comprising at least two pod shell elements which are designed to enclose the receiving space when the weapons pod is in a closed state and to open the receiving space when the weapons pod is in an open state in order to launch the guided missile, and comprising an actuating apparatus which is designed to actuate at least certain portions of the at least two pod shell elements simultaneously and/or sequentially in order to reach the open and/or the closed state.

In the case of an aircraft, in particular supersonic stealth aircraft, the object is achieved in particular by said aircraft comprising at least one corresponding weapons pod.

The weapons pod may be designed as fastenable externally to the aircraft. The guided missile may, for example, be a guided weapon such as an air-to-air missile for long distances (Beyond Visual Range—BVR). The actuating apparatus may be designed as integrated completely in the weapons pod. The pod shell elements may be designed in such a way that the weapons pod has a low radar cross section. To this end, the weapons pod may have the most streamlined possible outer profile with a low radar cross section, which can also help to provide a supersonic capability of the weapons pod. Outer surfaces of the weapons pod may have parallel angles between one another, which can be matched to parallel angles of the outer surfaces of the aircraft. In addition, at least certain portions of the weapons pod may be provided with a radar beam-absorbing coating. The at least two pod shell elements may lie as flush as possible against one another in the closed state.

This makes it possible to provide a weapons pod which encloses a weapon, such as for example an air-to air missile of a particular type, such that it can be carried as additional weaponry without significantly impairing the radar cross section of the aircraft. A weapons pod design which is as lightweight and streamlined or small as possible can also keep the air resistance of the weapons pod so low that it does not influence, or only barely influences, the maximum speed of the aircraft and thus maintains the supersonic capability thereof, i.e. the capability to fly at speeds greater than the speed of sound. It may be only when launching weapons that the weapons pod opens and releases a weapon received thereon or the holding apparatus thereof for the launching of the weapon, in order to reveal the holding apparatus, which could otherwise negatively influence the radar cross section of the aircraft, only for the shortest possible time.

The aircraft may have under its wings pylons to which the weapons pod may be designed to be fastenable. The pylons may be standard pylons, as are provided for example for receiving external tanks. The solution according to the invention thus has the advantage of making it possible to provide a weapons pod with supersonic capability and stealth properties which, fastened to standard pylons, makes it possible to increase the weapon-carrying capacities of an aircraft, in particular stealth aircraft, without significantly increasing its radar cross section or significantly reducing its maximum speed.

Advantageously, a corresponding weapons pod may be designed in particular such that it allows additionally carried weapons to be launched with the lowest possible radar cross section in the front view of the aircraft. A preferably small form factor of the weapons pod makes it possible to maintain a high performance capability of an aircraft. The small form factor of the weapons pod can help in it bringing about only a very low differential air resistance. The weapons pod may in particular be adapted to the respective weapon to be carried in such a way that it has the smallest and most lightweight design possible. Even for non-dedicated stealth aircraft, such as for example fourth-generation fighter aircraft, like the Eurofighter, such a weapons pod may be advantageous because it does not contribute significantly to the radar cross section and can conceal any elements of a carried weapon and the holding apparatus thereof that have a negative influence on the radar cross section.

According to one embodiment of a weapons pod, provision may be made for the actuating apparatus to comprise a drive unit which is designed to drive the at least two pod shell elements. For instance, it is for example possible to provide a single drive unit in order to actuate the at least two and/or all the pod shell elements for the opening and closing of the weapons pod. This can help in designing the weapons pod to be as small and lightweight, and uncomplicated and reliable, as possible, which in turn simplifies integration of the weapons pod into a weapons system or weapons carrier.

According to one embodiment of a weapons pod, provision may be made for the actuating apparatus to comprise a mechanical actuating device which is designed to actuate at least certain portions of the at least two pod shell elements simultaneously and/or sequentially one after the other. For instance, it is for example possible for the actuating device to implement respective drive forces of the drive unit in order to actuate the at least two and/or all the pod shell elements for the opening and closing of the weapons pod. This can also help in designing the weapons pod to be as small and lightweight, and uncomplicated and reliable, as possible, which again simplifies integration of the weapons pod into a weapons system or weapons carrier.

According to one embodiment of a weapons pod, provision may be made for the actuating device to be configured to actuate the at least two pod shell elements simultaneously and/or sequentially. It is thus possible for the drive unit to cooperate with the actuating device, as far as possible without electronic control and/or sensors, in such a way that the at least two pod shell elements are actuated simultaneously and/or sequentially in a mechanical manner. Thus, dimensions and weight of the weapons pod can be kept as small as possible and its uncomplicated and reliable actuation can be enabled, whereby its integration into a weapons system or weapons carrier can be further simplified.

According to one embodiment of a weapons pod, provision may be made for the actuating device to comprise a linear guide arrangement and a transmission rod arrangement which are designed to cooperate for the simultaneous and/or sequential actuation of the at least two pod shell elements. The drive unit can thus act as uniformly as possible on the linear guide arrangement and act on the transmission rod arrangement. The linear guide arrangement and transmission rod arrangement can thus actuate various pod shell elements simultaneously and/or sequentially. This can additionally help in designing the weapons pod to be as small and lightweight, and uncomplicated and reliable, as possible, which further simplifies integration of the weapons pod into a weapons system or weapons carrier.

According to one embodiment of a weapons pod, provision may be made for the linear guide arrangement to comprise a carriage which is configured to actuate the transmission rod arrangement from a carrying-along position by way of a driver. The carriage and driver may cooperate for the simultaneous and/or sequential actuation of the at least two pod shell elements. This can also help in designing the weapons pod to be as small and lightweight, and uncomplicated and reliable, as possible, which further simplifies integration of the weapons pod into a weapons system or weapons carrier.

According to one embodiment of a weapons pod, provision may be made for the at least two pod shell elements to comprise a linearly displaceably guided rear cone and at least one hinged pivoting door. The rear cone may be designed as extendable rearward counter to a flight direction and have an air outlet on its rear end portion. Two pivoting doors may be designed as openable in a pincer-like manner in a projection along a cross section of the weapons pod. Thus, in a first phase of a sequence for opening the weapons pod, the rear cone may first travel rearward. In a second phase of the sequence, the pivoting doors may open, for example by each carriage cooperating with the driver. For example, the carriage may actuate the rear cone. The transmission rod arrangement may actuate the pivoting doors. During closing, the rear cone and pivoting doors may carry out this sequence in reverse order. This makes it possible to provide a largely mechanically controlled actuating sequence, which can also help in designing the weapons pod to be as small and lightweight, and uncomplicated and reliable, as possible, which helps to simplify integration of the weapons pod into a weapons system or weapons carrier.

According to one embodiment of a weapons pod, provision may be made for the at least two pod shell elements to have end faces with integrated interlocking profiles which interlockingly engage in one another in the closed state in order to close at least one gap between the at least two pod shell elements. Profiles which are situated opposite one another may be designed as complementary to one another. This makes it possible to further reduce the radar cross section and/or air resistance of the weapons pod.

According to one embodiment of a weapons pod, provision may be made for its inner contour to be designed to enclose an outer contour of the guided missile in as close proximity as possible. For example, the weapons pod may be customized as far as possible for a respective weapon and enclose it in as complementary a manner as possible. For instance, a multiplicity of weapons, in particular missiles, have standardized cross sections and differ in terms of their special dimensions at most by the positioning of their fin, rudder, or similar. This makes it possible to keep the radar cross section and/or air resistance of the weapons pod as low as possible. Here, a certain safety distance between the weapons pod and the weapon should be observed in order to avoid damage as a result of mutual contact brought about by vibrations.

### BRIEF DESCRIPTION OF THE FIGURES

A more specific description of some details is given below with reference to the accompanying drawings. The illustrations are schematic and not true to scale. Identical reference signs refer to identical or similar elements. In the drawings:

FIG. 1 shows a schematic perspective view of an exemplary embodiment of an aircraft bearing two weapons pods;

FIG. 2 shows a schematic bottom view of an exemplary embodiment of a weapons pod in the closed state;

FIG. 3 shows a schematic side view of the exemplary embodiment of a weapons pod shown in FIG. 2;

FIG. 4 shows a schematic front view of the exemplary embodiment of a weapons pod shown in FIGS. 2 and 3;

FIG. 5 shows a schematic semi-transparent perspective view of the exemplary embodiment of a weapons pod shown in FIGS. 2 to 4 laterally from the front and above;

FIG. 6 shows a schematic semi-transparent perspective view of the exemplary embodiment of a weapons pod shown in FIGS. 2 to 5 laterally from the rear and below;

FIG. 7 shows a schematic semi-transparent perspective view of the exemplary embodiment of a weapons pod shown in FIGS. 2 to 6 laterally from the front and above in a semi-open state; and FIG. 8 shows a schematic semi-transparent perspective view of the exemplary embodiment of a weapons pod shown in FIGS. 2 to 7 laterally from the front and above in an open state after the launching of a weapon.

### DETAILED DESCRIPTION

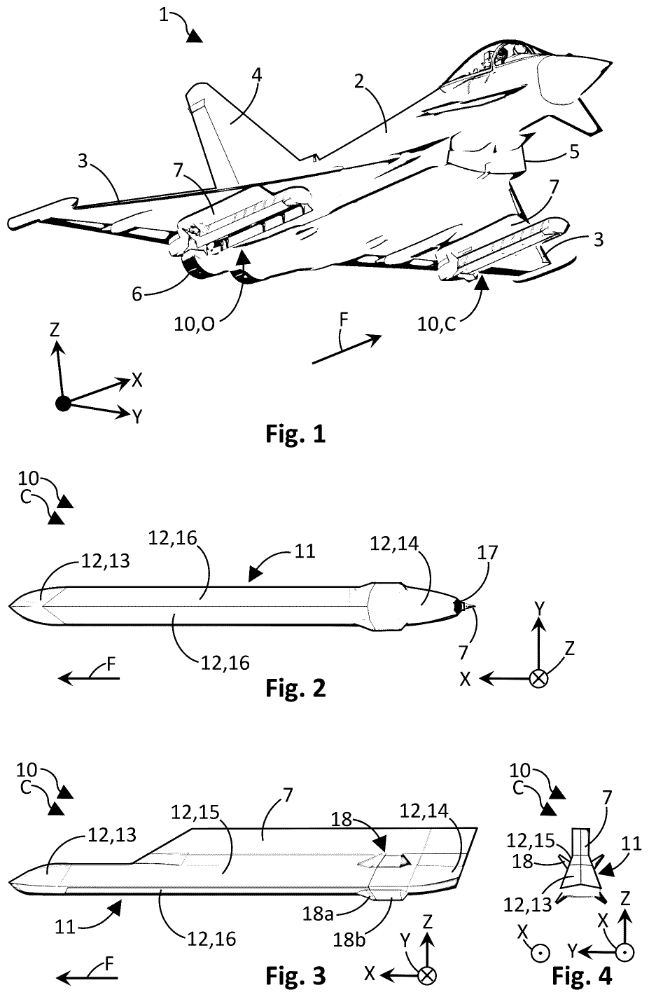

FIG. 1 shows a schematic perspective view of an aircraft 1, preferably in the form of a stealth aircraft. The aircraft 1 has a fuselage 2, wings 3, a vertical tail unit 4 and also air inlets 5 and air outlets 6. In particular in the region of the wings 3, vertical tail units 4 and also air inlets 5 and air outlets 6. Pylons 7 are fastened to the two wings 3 and each bear a weapons pod 10, of which one is illustrated in the open state O and one in the closed state C. The aircraft 1 extends in a longitudinal direction X, transverse direction Y and vertical direction Z, which together define a Cartesian coordinate system, the aircraft 1 being designed to fly in a flight direction F running substantially parallel to the longitudinal direction X.

FIG. 2 shows a schematic bottom view of an exemplary embodiment of a weapons pod 10 in the closed state C. The weapons pod 10 has a housing body or a shell 11 with a series of pod shell elements 12. For example, one pod shell element 12 is designed as a front cone 13, one as a rear cone 14, and two as side parts 15 (see FIG. 3) and two as pivoting doors 16. In the closed state C, the respective outer edges of the pod shell elements 12 lie flush against one another. On the rear side of the weapons pod 10, a rear outlet 17 is formed in the shell 11 at the rear end of the rear cone.

FIG. 3 shows a schematic side view of the exemplary embodiment of a weapons pod 10 shown in FIG. 2. Here, it becomes clear that fin-receiving portions 18 are formed in the shell 11. The fin-receiving portions 18 each have a front part 18a and a rear part 18b. In the present exemplary embodiment, an upper front part 18a is arranged on the side part 16 and a lower front part 18a is arranged on the pivoting door 16. The rear parts 18b are arranged on the rear cone 14.

FIG. 4 shows a schematic front view of the exemplary embodiment of a weapons pod 10 shown in FIGS. 2 and 3. Here, it becomes clear that the fin-receiving portions 18 extend in a star-shaped manner away from a central axis of the weapons pod 10. The side parts 15 of the weapons pod 10 merge flush into the pylons 7 and are at the same angle relative to the pylon 7, that is to say to the vertical direction Z, as leading edges of the front cone 13 can be oriented with respect to the transverse direction Y.

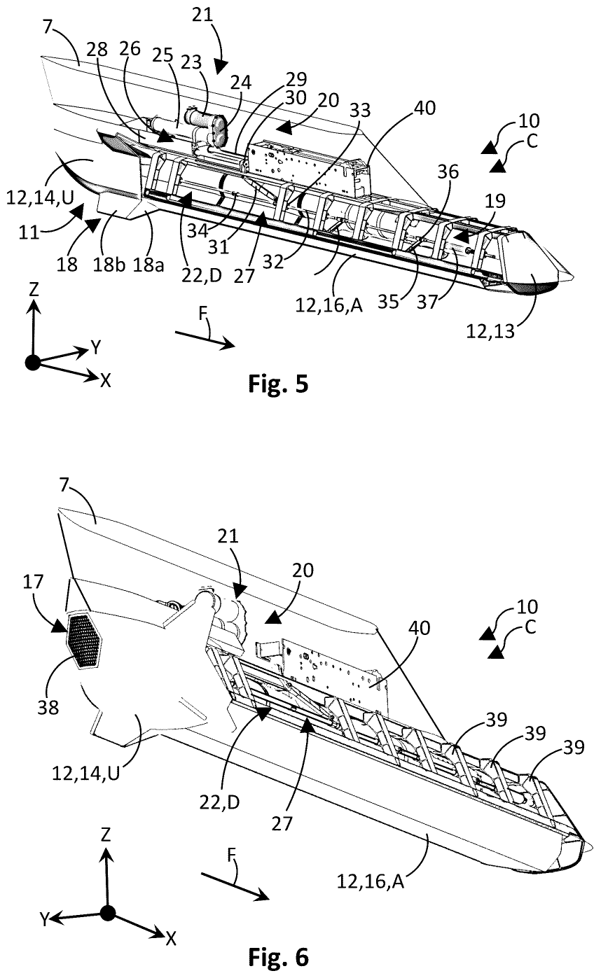

FIG. 5 shows a schematic semi-transparent perspective view of the exemplary embodiment of the weapons pod 10 shown in FIGS. 2 to 4 laterally from the front and above. In this semi-transparent view, the side parts 15 are omitted and the pylon 7 is illustrated in transparent form to the extent that only the outer contour thereof is visible, such that a glimpse into a receiving space 19 of the weapons pod 10 is afforded. In the closed state C, the receiving space 19 is enclosed by the shell 11 and can extend into the pylons 7. An actuating apparatus 20 of the weapons pod 10 is accommodated in the receiving space 19.

The actuating apparatus 20 has a drive unit 21 and an actuating device 22. The drive unit 21 has a motor 23, a transmission 24 and a linear drive 25. The motor 23 may be an electric motor, for example a servomotor or stepper motor, which by way of the transmission 24, for example a simple gearwheel transmission with a drive pinion on a drive shaft (not shown) of the motor and a gearwheel on an output shaft of the linear drive 25. The linear drive 25 may be designed as a worm gear drive or similar.

The actuating device 22 may comprise a linear guide arrangement 26 and a transmission rod arrangement 27. The linear guide arrangement 26 may comprise a carriage 28 and two guide rods 29 fastened to the carriage 28, a bridge 30 being fastened at the end of said guide rods. The carriage acts on the rear cone 14 and is coupled to the linear drive 25 of the drive unit 21 in a movement-transmitting manner, such that it is designed to be drivable by the latter substantially parallel to the longitudinal direction X. The bridge 30 is connected to the transmission rod arrangement 27 by way of an oblique intermediate linkage 31, while the guide rods 29, bridge 30 and/or intermediate linkage 31 can be understood already to be part of the transmission rod arrangement 27, i.e. can be considered to be comprised by the latter.

The transmission rod arrangement 27 comprises a central actuating rod 32 on which the intermediate linkage 31 is held displaceably along the longitudinal direction X by way of a sliding shoe 33 which is fastened thereto and can enclose the actuating rod 32. In the closed state C shown here, the sliding shoe 33 can slide counter to the longitudinal direction X on the actuating rod 32 until it strikes a driver 34. Furthermore, the transmission rod arrangement 27 comprises lever rods 35 which are connected on one side to the actuating rod 32 by way of joint elements 36, for example in the form of ball joints. The lever rods 35 are connected on the other side to the pivoting doors 16, in order to be able to swing them open and closed.

Furthermore, the actuating apparatus 20 comprises at least one spring element 37. The spring element 37 can counteract a drive force generated by the drive unit 21 and have the constant tendency to move the weapons pod 10 into the closed state C. In the present exemplary embodiment, the actuating rod 32 is connected, at its end facing in the flight direction F, to the spring element 37 in a force-transmitting manner, said spring element applying a spring force which is in the flight direction F and has the constant tendency to move the actuating rod 32 into a front end position D in which the weapons pod 10 is in the closed state C. In the closed state C shown here, the rear cone 14 is in a front position U and the pivoting doors 16 are in a closed position A.

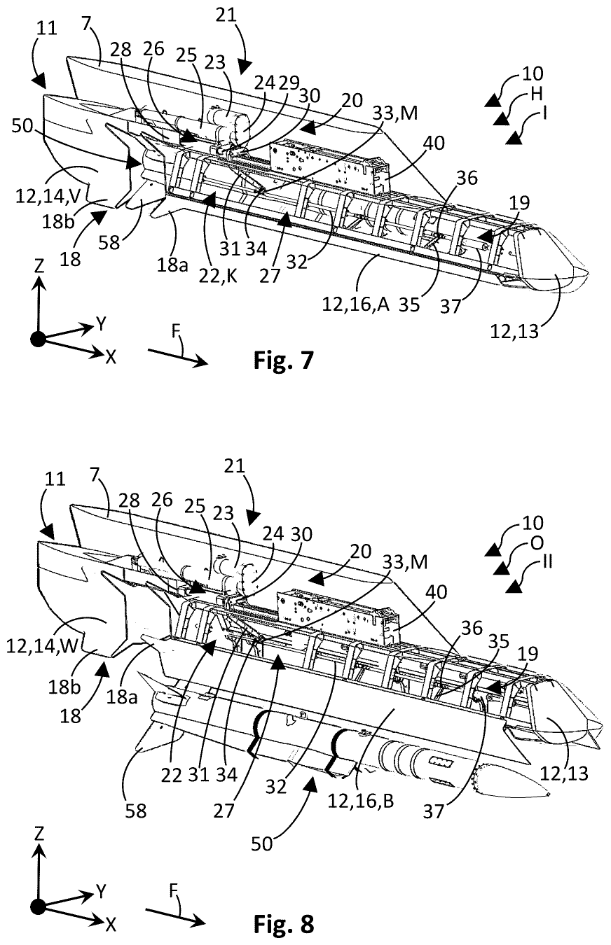

FIG. 6 shows a schematic semi-transparent perspective view of the exemplary embodiment of the weapons pod 10 shown in FIGS. 2 to 5 in the closed state C laterally from the rear and below. Here, it becomes clear that the rear outlet 17 may be provided by a grille 38 or closed in such a way that, on the one hand, a propulsion jet can exit therefrom and, on the other hand, radar-absorbing properties of the grille 38 are utilized, in order to keep the radar cross section of the aircraft 1 as low as possible. Furthermore, it is apparent that the pivoting doors 16 may be held in a pivotably movable manner on frames 39 of the weapons pod 10 by way of hinges (not shown). A holding apparatus 40 of the weapons pod 10 for a weapon 50 (see FIGS. 7 and 8) may project into the pylons 7.

FIG. 7 shows a schematic semi-transparent perspective view of the exemplary embodiment of the weapons pod 10 shown in FIGS. 2 to 6 laterally from the front and above in a semi-open state H. In the semi-open state H, the weapons pod 10 has completed a first sequential phase I of its opening sequence. In the first sequential phase I, at least one of the pod shell elements 12 may have been or be opened sequentially, whereas other or the rest of the pod shell elements 12 have not yet been moved or opened.

In the present exemplary embodiment, in the first opening sequence I, the rear cone 14 has been brought into a middle position or intermediate position V by having been moved to some extent rearward, i.e. counter to the flight direction F or longitudinal direction X. To this end, the drive unit 21 may move the carriage 28 to such an extent that it pushes the rear cone 14 into the intermediate position V. At the same time, the actuating device 22 may have been brought into a transition position K, in which the first sequential phase I passes into a second sequential phase II (see FIG. 8). In the transition position K, the transmission rod arrangement 27 may be in a carrying-along position M, from which further pod shell elements 12, such as here the pivoting doors 16, are also moved.

For example, the sliding shoe 33 may come to lie against the driver 34 in the carrying-along position M. To this end, the linear guide arrangement 26 may thus have moved the carriage 28, the guide rods 29, the bridge 30 and/or the intermediate linkage 31 to such an extent counter to the flight direction F that the sliding shoe 33 has slid along the hitherto unmoved actuating rod 32. The sliding shoe 33 then lies against the driver 34 counter to the flight direction F and can pull it along together with the actuating rod 32 counter to the flight direction F.

Furthermore, the weapon 50 or the rear thereof with a fin 58 is visible. The rear part 18b, formed on the rear cone, of the fin-receiving portion 18 has been pulled rearward away from the fin 58 counter to the flight direction F and has thus released said fin. The front part 18a, formed on the pivoting doors 16, of the fin-receiving portion 18 may still at least enclose the fin 58 or at least conceal it in a projection counter to the flight direction F, whereby the weapon 50 is received in the receiving space 19 of the weapons pod 10 so as to be still largely protected against aerodynamic influences and concealed from radar detection.

FIG. 8 shows a schematic semi-transparent perspective view of the exemplary embodiment of the weapons pod 10 shown in FIGS. 2 to 7 laterally from the front and above in an open state O after the launching of the weapon 50. To reach the open state O, the weapons pod 10 may have executed the second sequential phase II. To this end or in so doing, certain pod shell elements 12 may be actuated simultaneously. Thus, from the transition position K, for example the rear cone 14 and the pivoting doors 16 may be moved simultaneously, while the front cone may be designed as rigid or immobile.

In the present exemplary embodiment, the drive unit 21 may, to this end, move the carriage 28 further counter to the flight direction F. The carriage 28 may linearly move the rear cone 14 further counter to the flight direction F until it is in a rear position W. At the same time, the linear guide arrangement 26 may have moved the carriage 28, the guide rods 29, the bridge 30 and/or the intermediate linkage 31 to such an extent counter to the flight direction F that the sliding shoe 33 pulls along the driver 34 together with the actuating rod 32 counter to the flight direction F and thus the lever rods 35 rotate about their joint elements 36, as a result of which the lever rods 35 actuate the pivoting doors 16 by swinging them open and thus releasing the receiving space 19 together with the weapon 50 received therein. In the open position O of the weapons pod 10 that has now been reached, the rear part 18b of the fin-receiving portion 18 and the front part 18a of the fin-receiving portion 18 on the pivoting door 16 have completely released the fins 58 of the weapon 50.

The weapon 50 can then be launched from the holding apparatus 40, for example by the holding apparatus 40 being designed as an external launcher which ejects the weapon 50 counter to the vertical direction Z from the receiving space 19. The weapon 50 can then ignite its thruster. After the weapon 50 has been launched, the weapons pod 10 can execute a closing sequence, which first passes through the second sequential phase II and then the first sequential phase I. In other words, the opening sequence is reversed for the closing. In this case, the drive unit 21 and/or the spring element 37 can apply the required closing forces.

It should additionally be pointed out that “comprising” or “having” does not exclude other elements or steps, and “a”, “an” or “one” does not exclude a plurality. It is furthermore pointed out that features or steps that have been described with reference to one of the above exemplary embodiments may also be used in combination with other features or steps of other exemplary embodiments described above. Reference signs in the claims should not be interpreted as restricting.

List of reference signs

| | |
|---|---|
| 1 | Aircraft/stealth aircraft |
| 2 | Fuselage |
| 3 | Wing |
| 4 | Vertical tail unit |
| 5 | Air inlet |
| 6 | Air outlet |
| 7 | Pylon |
| 10 | Weapons pod |
| 11 | Housing body/shell |
| 12 | Pod shell element |
| 13 | Front cone |
| 14 | Rear cone |
| 15 | Side part |
| 16 | Pivoting door |
| 17 | Rear outlet |
| 18 | Fin-receiving portion |
| 18a | Front part |
| 18b | Rear part |
| 19 | Receiving space |
| 20 | Actuating apparatus |
| 21 | Drive unit |
| 22 | Actuating device |
| 23 | Motor |
| 24 | Transmission |
| 25 | Linear drive |
| 26 | Linear guide arrangement |
| 27 | Transmission rod arrangement |
| 28 | Carriage |
| 29 | Guide rod |
| 30 | Bridge |
| 31 | Intermediate linkage |
| 32 | Actuating rod |
| 33 | Sliding shoe |
| 34 | Driver |
| 35 | Lever rods |
| 36 | Joint elements |
| 37 | Spring element |
| 38 | Grille |
| 39 | Frame |
| 40 | Holding apparatus |
| 50 | Weapon/guided missile |
| 58 | Fin |
| I | First sequential phase |
| II | Second sequential phase |
| A | Closed position |
| B | Open position |
| C | Closed state |
| D | Front end position |
| E | Rear end position |
| F | Flight direction |
| H | Semi-open state |
| K | Transition position |
| M | Carrying-along position |
| O | Open state |
| S | Weapon retention state |
| R | Weapon release state |
| U | Front position |
| V | Intermediate position/middle |
| | position |
| W | Rear position |
| X | Longitudinal direction |
| Y | Transverse direction |
| Z | Vertical direction |

1. A weapons pod for a low observable aircraft, in particular for a supersonic stealth aircraft, comprising:
a receiving space for a guided missile,
at least two pod shell elements configured to enclose the receiving space when the weapons pod is in a closed state (C) and to open the receiving space when the weapons pod is in an open state (O) in order to launch the guided missile, and
an actuating apparatus configured to actuate at least certain portions of the at least two pod shell elements simultaneously and/or sequentially in order to reach the open and/or the closed state.

2. The weapons pod as claimed in claim 1, wherein the actuating apparatus comprises a drive unit configured to drive the at least two pod shell elements.

3. The weapons pod as claimed in claim 1, wherein the actuating apparatus comprises a mechanical actuating device configured to actuate at least certain portions of the at least two pod shell elements simultaneously and/or sequentially one after the other.

4. The weapons pod as claimed in claim 3, wherein the mechanical actuating device is further configured to actuate the at least two pod shell elements simultaneously and/or sequentially.

5. The weapons pod as claimed in claim 3, wherein the mechanical actuating device comprises a linear guide arrangement and a transmission rod arrangement, both configured to cooperate for the simultaneous and/or sequential actuation of the at least two pod shell elements.

6. The weapons pod as claimed in claim 5, wherein the linear guide arrangement comprises a carriage configured to actuate the transmission rod arrangement from a carrying-along position (M) by a driver.

7. The weapons pod (10) as claimed claim 1, wherein the at least two pod shell elements comprise a linearly displaceably guided rear cone and at least one hinged pivoting door.

8. The weapons pod as claimed in claim 1, wherein the at least two pod shell elements have end faces with integrated interlocking profiles which interlockingly engage in one another in the closed state in order to close at least one gap between the at least two pod shell elements.

9. The weapons pod as claimed in claim 1, wherein an inner contour thereof is configured to enclose an outer contour of the guided missile in as close proximity as possible.

10. An aircraft, comprising at least one weapons pod as claimed in claim 1.

11. The aircraft according to claim 10, wherein the aircraft is a supersonic stealth aircraft.
